(19) United States
(12) Patent Application Publication
(10) Pub. No.: US 2023/0254458 A1
(43) Pub. Date: Aug. 10, 2023

(54) LASER BEAM SCANNING SYSTEM WITH PHASE CALIBRATION AND COMPENSATION

(71) Applicant: First International Computer, Inc., Taipei City (TW)

(72) Inventors: Leo Ming Tz Chien, Taipei City (TW); Chien-Huei Dee, New Taipei City (TW); Jung-Kuan Tseng, New Taipei City (TW)

(21) Appl. No.: 18/059,798

(22) Filed: Nov. 29, 2022

Related U.S. Application Data
(60) Provisional application No. 63/308,291, filed on Feb. 9, 2022.

(51) Int. Cl. H04N 9/31; G02B 26/08

(52) U.S. Cl. CPC H04N 9/3135; H04N 9/3161; G02B 26/0833

(57) ABSTRACT

A laser beam scanning system includes a light source, a projection, a micro-mirror, a controller, and a light detection module. The light source generates a laser beam, and the micro-mirror deflects the laser beam to create a scan trajectory on the projection. The controller generates a control signal and a drive signal. The control signal turns the laser beam on and off, and the drive signal controls scan movements of the micro-mirror. The light detection module is placed at a margin of the projection. The light detection module includes a photo sensor underneath a light-blocking top layer having a slot to expose the photo sensor. The photo sensor generates a detection pulse in response to detection of the laser beam in one or more segments of the scan trajectory. The controller is operative to measure a detection pulse width in clock cycles.

### CROSS-REFERENCE TO RELATED APPLICATIONS

This application claims the benefit of U.S. Provisional Application No. 63/308,291 filed on Feb. 9, 2022, the entirety of which is incorporated by reference herein.

### TECHNICAL FIELD

Embodiments of the invention relate to laser beam scanning techniques and calibration of phase errors.

### BACKGROUND OF THE INVENTION

Laser beam scanning plays an important role in modern display systems. For example, a laser beam scanner can be used in a projection unit of an augmented reality (AR) device such as a head-on display (HUD) or a head-mounted display (HMD). However, the projection accuracy of a laser beam scanning system may deteriorate over time and may fluctuate due to temperature fluctuations. To maintain accuracy, a laser beam scanning system is calibrated from time to time to compensate for phase errors.

Conventional calibration techniques for laser beam scanning systems can be complex with limited accuracy. There is a need for a calibration technique that has low complexity and high accuracy for calibrating laser scanning systems.

### SUMMARY OF THE INVENTION

In one embodiment, a system is provided for calibrating laser beam scanning. The system includes a light source to generate a laser beam, a projection, a micro-mirror that deflects the laser beam to create a scan trajectory on the projection, a controller to generate a control signal and a drive signal. The control signal turns the laser beam on and off, and the drive signal controls the scan movements of the micro-mirror. The system further includes a light detection module at a margin of the projection. The light detection module includes a photo sensor underneath a light-blocking top layer having a slot to expose the photo sensor. The photo sensor generates a detection pulse in response to the detection of the laser beam in one or more segments of the scan trajectory. The controller is operative to measure a detection pulse width in clock cycles.

In another embodiment, a method is provided for calibrating laser beam scanning. The method includes the step of a controller generating a control signal and a drive signal. The control signal turns a laser beam on and off, and the drive signal controls the scan movements of a micro-mirror that deflects the laser beam to create a scan trajectory on a projection. The method further includes the step of the controller receiving a detection pulse from a photo sensor placed at a margin of the projection. The photo sensor is underneath a light-blocking top layer having a slot to expose the photo sensor. The detection pulse width indicates a segment of the scan trajectory detected by the phone sensor. The method further includes the step of measuring the detection pulse width in clock cycles.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a block diagram of a laser beam scanning system according to one embodiment.

FIG. 2 illustrates an example of the laser beam scanning system in FIG. 1.

FIG. 3 is a diagram illustrating a scenario with no phase error according to one embodiment.

FIG. 4 is a diagram illustrating a scenario with no phase error according to another embodiment.

FIG. 5 is a diagram illustrating a scenario with phase errors according to one embodiment.

FIG. 6 is a flow diagram illustrating a method for calibrating a laser beam scanning system according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention calibrate phase errors in a laser beam scanning system. Phase errors can cause pixels of a projected image to deviate from their intended positions, producing distortions in the projected image. The phase calibration technique described herein measures the amount of deviation using a high-frequency clock to achieve high precision.

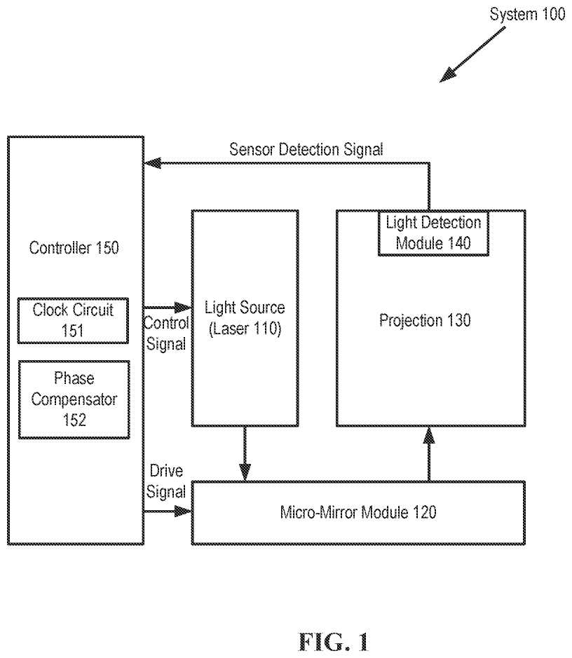

FIG. 1 illustrates a block diagram of a laser beam scanning system 100 according to one embodiment. The system 100 may be part of a projection device, which projects an image to a projection screen (not shown). The system 100 includes a light source (e.g., a laser 110), a micro-mirror module 120, a projection 130, a light detection module 140, and a controller 150. The laser 110 generates a collimated laser beam of any of the red (R), green (G), and blue (B) colors or any combinations thereof. The micro-mirror module 120 includes a micromechanical scanning mirror, such as a micro-electro-mechanical system (MEMS) scanner, that deflects the laser beam to the projection 130. The controller 150 generates a control signal to turn on and off the laser beam at predetermined time instants. The controller 150 also generates a drive signal to control the scan movements (e.g., scan angles) of the micro-mirror module 120 such that the laser beam deflected by the micro-mirror module 120 draws a sinusoidal scan trajectory on the projection 130. The controller 150 may include a general-purpose circuit (e.g., a processor, a microcontroller, etc.) executing control software, a special-purpose circuit, or a combination of both.

The controller 150 also includes a clock circuit 151 to generate clock pulses. The controller 150 further includes a phase compensator module 152 to adjust the drive signal to the micro-mirror module 120 and/or the control signal to the laser 110. The phase compensator module 152 may be a general-purpose circuit, a special-purpose circuit, or a combination of both. As will be described in more detail below, the controller 150 uses both the clock circuit 151 and the phase compensator module 152 for phase error calibration and compensation in response to a sensor detection signal generated by the light detection module 140.

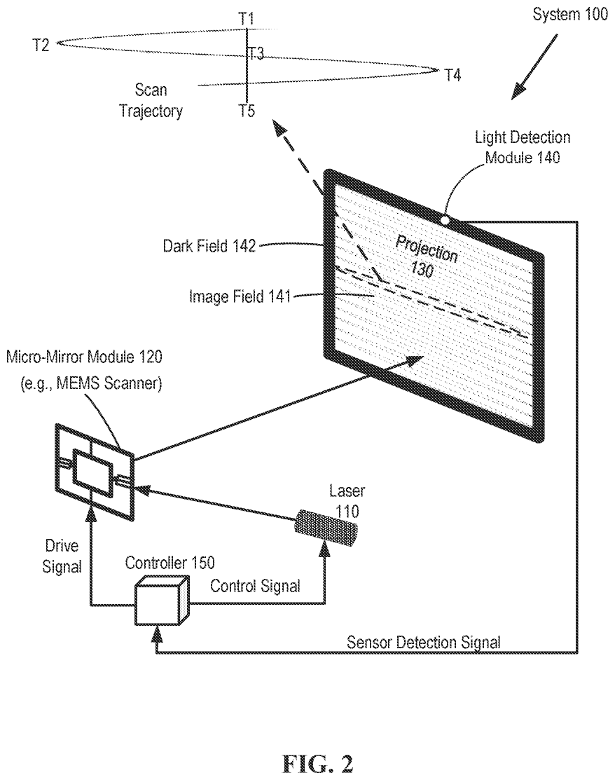

FIG. 2 illustrates an example of the laser beam scanning system 100. The laser 110 is the light source; any of the red (R), green (G), blue (B) color laser beams may be used for phase calibration. The micro-mirror module 120 includes a micro-mirror that spins along a vertical axis and a horizontal axis to draw a scan trajectory in a scan field on the projection 130. The scan field includes an image field 141 in the middle portion of the projection 130 and a dark field 142 (represented by a dark outline) at the margin surrounding the image field 141. For example, the image field 141 may occupy 90% of projection width and height, and the dark field 142 at each left/right/top/bottom margin may occupy 5% of the corresponding projection dimension. It is understood a different percentage may be used. The light detection module 140 is placed at a margin of the projection 130 in the dark field 142. For image projection, the controller 150 generates a control signal that turns off the laser 110 when the scan trajectory enters the dark field 142 and turns on the laser 110 when the scan trajectory enters the image field 141. For phase calibration and compensation, the control signal may also turn on the laser 110 when the scan trajectory is in the dark field 142 at predetermined time instants such that the light detection module 140 can detect the laser beam. The timing of the control signal and/or the drive signal can be adjusted to correct phase errors in the laser beam scanning.

In the embodiment of FIG. 2, the light detection module 140 is placed in the dark field 142 at the top margin of the projection 130. In alternative embodiments, the light detection module 140 may be placed in a different location of the dark field 142. The controller 150 sends a drive signal to the micro-mirror module 120 to control the scan movements. When the scan trajectory enters the dark field 142, the controller 150 uses the control signal to turn off the laser beam. When the scan trajectory crosses over the location of the light detection module 140 in the dark field 142, the controller 150 turns on the laser beam for a period of time to light up N pixels. If there is no phase error in the system 100, all N pixels can be detected by the light detection module 140. With phase errors, the light detection module 140 can detect less than N pixels. The light detection module 140 generates a sensor detection signal to indicate to the controller 150 the detected amount of light.

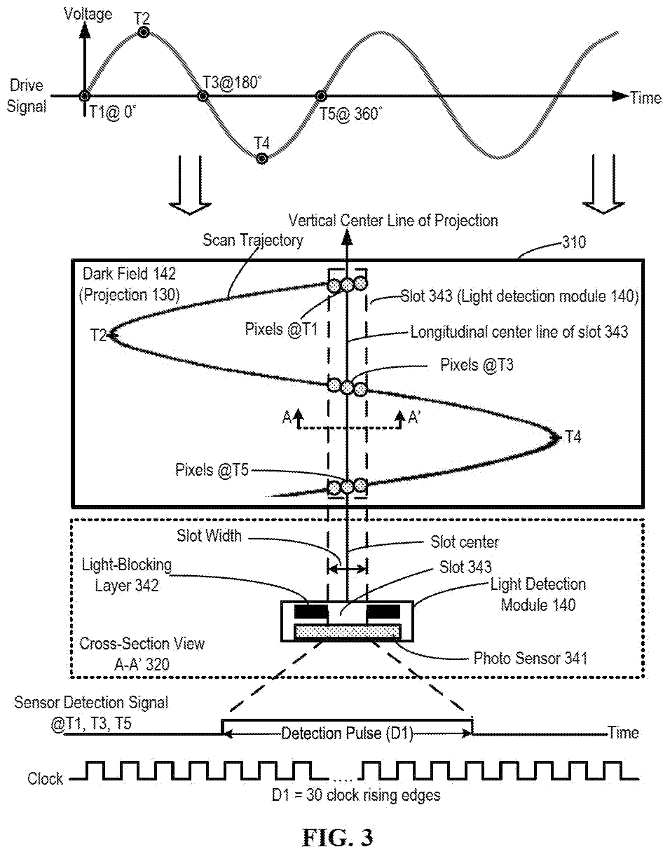

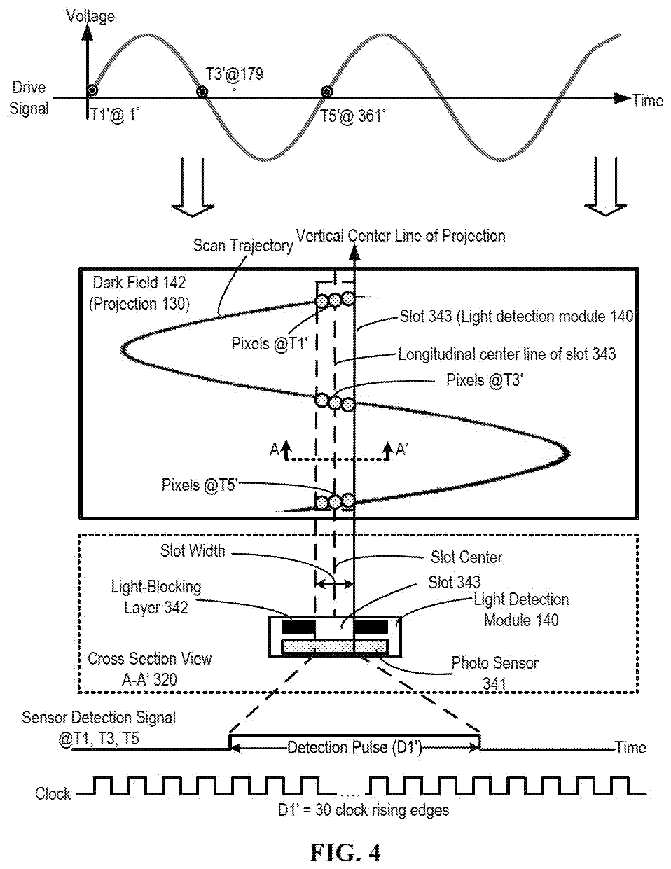

FIG. 2 also shows horizontal raster scanning in bi-directional and sinusoidal motion. The time duration from T1 to T5 is called a horizontal scan cycle. When there is no phase error, the laser-scanned pixels on the projection 130 at time instants T1, T3, and T5 are all aligned, as shown in the examples in FIG. 3 and FIG. 4.

FIG. 3 is a diagram illustrating a scenario with no phase error according to one embodiment. FIG. 3 shows, from top to bottom, the drive signal, a portion of the dark field 142 on the projection 130 (shown in a solid-line block 310), a cross-section view 320 A-A′ (shown in a dotted-line block 320), and a sensor detection signal. Referring also to FIG. 1 and FIG. 2, the drive signal at the top of FIG. 3 is generated by the controller 150 to drive the scan movements of a MEMs scanner (e.g., the micro-mirror module 120). In this example, the voltage vs. time curve of the drive signal is a sinusoidal curve, but alternative signal curves may be used. A drive signal cycle (T1-T5) corresponds to a horizontal scan cycle, where T1, T3, and T5 are the time instants corresponding to 0°, 180°, and 360° of the drive signal phases, respectively. It is understood that more than one drive signal cycle may be used for calibration.

FIG. 3 further shows (in the solid-line block 310) that the light detection module 140 is placed on the vertical center line of the projection 130 in the dark field 142. The light detection module 140 extends longitudinally along the vertical center line. The light detection module 140 includes a slot 343 (shown in a dashed outline) through which the scanned laser can reach a photo sensor 341. In this example, the slot's longitudinal center line coincides with the vertical center line of the projection 130.

FIG. 3 provides further details of the light detection module 140 in the cross-section view A-A′ 320. The light detection module 140 includes the photo sensor 341 (e.g., a photodiode) underneath a light-blocking layer 342. The light-blocking layer 342 includes the slot 343, which is an opening that allows laser beams to pass and reach the photo sensor 341. The width of the slot 343 in this example allows 3 laser-scanned pixels to pass through, and the slot center is aligned with the vertical center line of the projection 130.

For calibration purposes, the controller 150 turns on the laser beam for a predetermined short duration when the drive signal is at 0°, 180°, and 360°. As an example, the short duration may be the amount of time to scan N pixels (e.g., 3 pixels) on the projection 130. The drive signal causes the MEMs scanner to scan the laser beam on the projection 130 to form groups of 3 pixels at each of the time instants T1, T3, and T5. When there is no phase error, the center pixels of the 3-pixel groups at these time instants form a straight vertical line. In the example of FIG. 3, this straight vertical line is the vertical center line of the projection 130. Furthermore, when there is no phase error, the 3-pixel laser can pass through the entire width of the slot 343 to reach the photo sensor 341 at each T1, T3, and T5. The photo sensor 341, in response, generates a sensor detection signal including a detection pulse. The width of the detection pulse can be measured by the number of clock cycles generated by the clock circuit 151 of the controller 150. A high clock frequency (e.g., on the order of megahertz to gigahertz) enables high-precision measurement of the detection pulse width. As a non-limiting example, the detection pulse width (D1) may be measured by the number of rising clock edges; e.g., D1=30.

In one embodiment, the length of the slot (i.e., along the direction of the vertical center line) may allow the photo sensor 310 to detect the laser beam at more than one segment of the scan trajectory at more than one time instant. Referring again to the solid-line block 310 in FIG. 3, the scan trajectory crosses over the slot 343 three times at T1, T3, and T5. That is, the photo sensor 341 can detect a 3-pixel group at each of T1, T3, and T5. The controller 150 may calculate an average of the detection pulse widths at these time instants. The controller 150 may also calculate the center point of each detection pulse width to determine whether the center points are aligned.

In one embodiment, the drive signal may have a frequency of P kHz (e.g., P=25). Each cycle of the drive signal corresponds to one horizontal scan cycle. The projection display may have 1280 (fast axis)×720 (slow axis) pixel resolution, which means one horizontal scan cycle corresponds to 1280 pixels. Phase errors cause the pixels to deviate from their intended positions on the projection display. Phase error measurements based on the drive signal cycle or the horizontal scan cycle (e.g., in terms of the number of pixels) have limited precision, because of its relatively low frequency (e.g., on the order of kHz) compared to the clock signal of the controller (e.g., on the order of MHz to GHz). It is understood that the frequencies, the number of pixels, and the pixel resolution mentioned in this disclosure are non-limiting examples.

FIG. 4 is a diagram illustrating a scenario with no phase error according to another embodiment. This example shows that the light detection module 140 can be placed in the dark field 142 of the projection at a location different from what is shown in FIG. 3. For example, the light detection module 140 may be placed in the dark field 142 to the right or left of the vertical center line. In this example, the longitudinal center line of the slot 343 is shifted to the left of the vertical center line of the projection 130. In some scenarios, this positional shift may be caused by an imprecise placement of the light detection module 140.

When the light detection module 140 is shifted from the vertical center line of the projection 130, the 3-pixel groups scanned by the laser beam also need to shift correspondingly to allow maximum light to pass through the slot 343. In this example, the shifting of the 3-pixel groups can be achieved by turning on the laser beam at T1′, T3′, and T5′, which correspond to 1°, 179°, and 361° of the drive signal phases, respectively. To calibrate the laser beam scanning, the controller 150 turns on the laser beam for a predetermined short duration when the drive signal is at 1°, 179°, and 361°. The drive signal causes the MEMs scanner to scan the laser beam on the projection 130 to form groups of 3 pixels at T1′, T3′, and T5′. When there is no phase error, the center pixels of the 3-pixel groups at these time instants form a straight vertical line, which aligns with the slot center of the light detection module 140. Thus, the laser beam can pass through the entire width of the slot 343 to reach the photo sensor 341 to form a 3-pixel group at each T1′, T3′, and T5′, and the detection pulse width (D1′) is the same as in the example of FIG. 3; e.g., D1′=30.

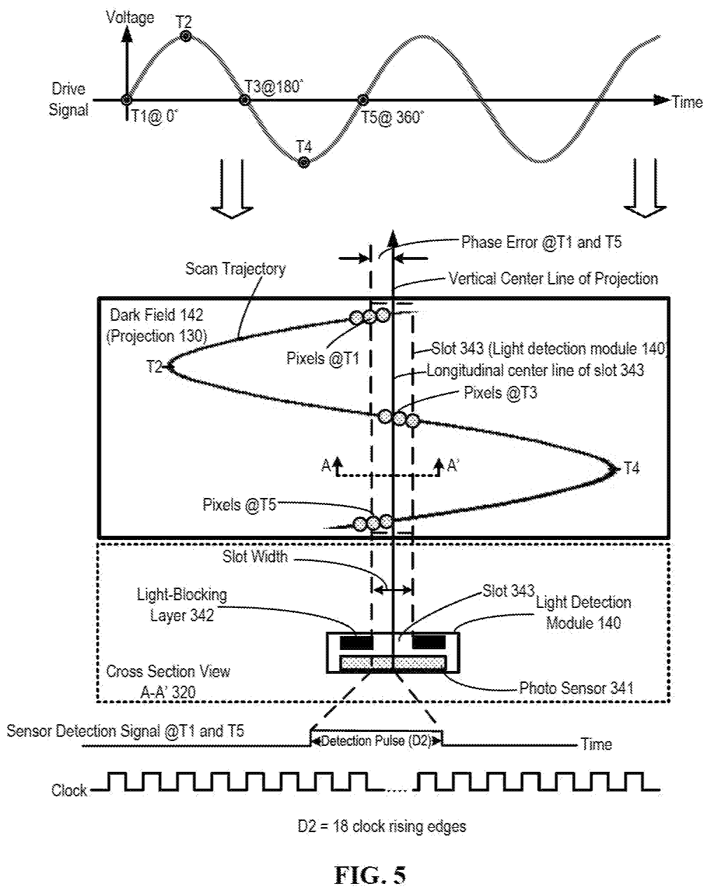

FIG. 5 is a diagram illustrating a scenario with phase errors according to one embodiment. Similar to the example of FIG. 3, the signal at the top is the drive signal and the longitudinal center line of the slot 343 is aligned with the vertical center line of the projection 130. The controller 150 turns on the laser beam for a predetermined short duration at time instants T1, T3, and T5. The drive signal at T1, T3, and T5 (corresponding to 0°, 180°, and 360°, respectively) causes the MEMs scanner to scan pixels on the projection 130 at T1, T3, and T5; e.g., 3 pixels at each time instant. However, the 3-pixel groups at these time instants do not form a straight vertical line, indicating a phase error. Thus, only a portion of the 3 pixels at each T1, T3, and T5 can pass through the slot 343 and reach the photo sensor 341. As a non-limiting example, the detection pulse width (D2) measured at T1 and T5 may be equal to 18 rising clock edges; e.g., D2=18. The detection pulse width measured at T3 is less than D1 and may be the same or different from 18 clock cycles. The controller 150 may calculate the center point of each detection pulse to obtain the center point that deviates from the longitudinal center line of the slot 343. The controller 150 may compute an average of these detection pulse widths in clock cycles to obtain an averaged indication of phase errors.

The shortened detection pulse length (D2) indicates the existence of a phase error to the controller 150. In one embodiment, the controller 150 may adjust the timing of the drive signal (e.g., by shifting the drive signal's sinusoidal curve in time) to compensate for the phase error until D2=D1 and the 3-pixel groups at T1, T3, and T5 form a straight vertical line. Alternatively, the controller 150 may adjust the timing of the control signal that turns on and off the laser 110 (e.g., by shifting the timing of turning on and off the laser beam) to compensate for the phase error until D2=D1 and the 3-pixel groups at T1, T3, and T5 form a straight vertical line.

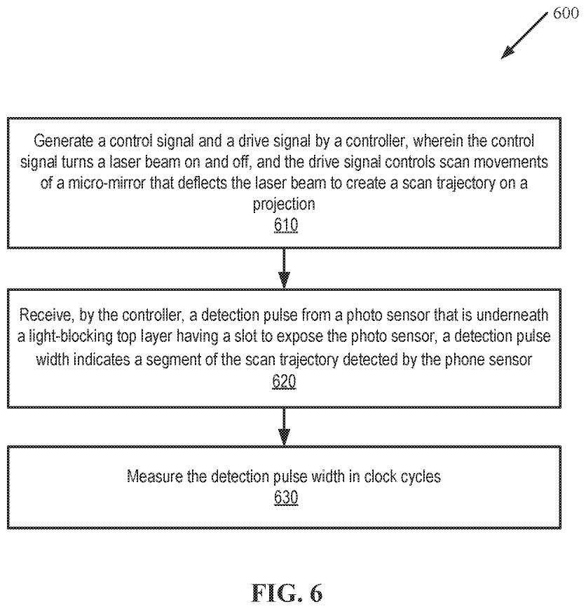

FIG. 6 is a flow diagram illustrating a method 600 for calibrating a laser beam scanning system according to one embodiment. Method 600 may be performed by the system 100 in FIG. 1 and FIG. 2; more specifically, the controller 150 in FIG. 1 and FIG. 2. Method 600 begins with the controller at step 610 generating a control signal and a drive signal. The control signal turns a laser beam on and off, and the drive signal controls scan movements of a micro-mirror that deflects the laser beam to create a scan trajectory on a projection. The controller at step 620 receives a detection pulse from a photo sensor that is underneath a light-blocking top layer having a slot to expose the photo sensor. The detection pulse width indicates a segment of the scan trajectory detected by the phone sensor. The controller at step 630 measures the detection pulse width in clock cycles.

In one embodiment, the controller is further operative to compare a measured number of clock cycles (D2) with D1, where D1 is a number of clock cycles when corresponding pixels in the segments of the scan trajectory form a vertical line. The controller adjusts the timing of at least one of the drive signal and the control signal when D2 is less than D1.

In one embodiment, the controller is further operative to turn on the laser beam to generate N consecutive pixels in each of the one or more segments of the scan trajectory. The controller further compares a measured number of clock cycles (D2) with D1, wherein D1 is a number of clock cycles when the photo sensor detects all of the N consecutive pixels in each of the one or more segments of the scan trajectory. The width of the slot is equal to the width of the N consecutive pixels.

In one embodiment, the light detection module is positioned in a dark field of the projection where the laser beam is turned on and off for calibration. The longitudinal center line of the slot is aligned with or parallel to a vertical center line of the projection. The controller is further operative to compute a center point of the detection pulse width in clock cycles. The photo sensor detects multiple groups of consecutive pixels at respective time instants, and the controller computes an average of detection pulse widths in clock cycles. The clock cycles have a frequency that is higher than the number of pixels in a horizontal scan cycle.

The operations of the flow diagram of FIG. 6 have been described with reference to the exemplary embodiments of FIG. 1 and FIG. 2. However, it should be understood that the operations of the flow diagram of FIG. 6 can be performed by embodiments of the invention other than the embodiments of FIG. 1 and FIG. 2, and the embodiments of FIG. 1 and FIG. 2 can perform operations different than those discussed with reference to the flow diagram. While the flow diagram of FIG. 6 shows a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A system for calibrating laser beam scanning, comprising:
a light source to generate a laser beam;
a projection;
a micro-mirror that deflects the laser beam to create a scan trajectory on the projection;
a controller to generate a control signal and a drive signal, wherein the control signal turns the laser beam on and off, and the drive signal controls scan movements of the micro-mirror; and
a light detection module at a margin of the projection, wherein the light detection module includes a photo sensor underneath a light-blocking top layer having a slot to expose the photo sensor, wherein the photo sensor generates a detection pulse in response to detection of the laser beam in one or more segments of the scan trajectory,
wherein the controller is operative to measure a detection pulse width in clock cycles.

2. The system of claim 1, wherein the controller is further operative to compare a measured number of clock cycles (D2) with D1, wherein D1 is a number of clock cycles when corresponding pixels in segments of the scan trajectory form a vertical line.

3. The system of claim 2, wherein the controller is further operative to adjust timing of at least one of the drive signal and the control signal when D2 is less than D1.

4. The system of claim 2, wherein the controller is further operative to adjust timing of the control signal when D2 is less than D1.

5. The system of claim 1, wherein the controller is further operative to turn on the laser beam to generate N consecutive pixels in each of the one or more segments of the scan trajectory.

6. The system of claim 5, wherein the controller is further operative to compare a measured number of clock cycles (D2) with D1, wherein D1 is a number of clock cycles when the photo sensor detects all of the N consecutive pixels in each of the one or more segments of the scan trajectory.

7. The system of claim 5, wherein a width of the slot is equal to a width of the N consecutive pixels.

8. The system of claim 1, wherein the light detection module is positioned in a dark field of the projection where the laser beam is turned on and off for calibration.

9. The system of claim 1, wherein a longitudinal center line of the slot is aligned with or parallel to a vertical center line of the projection.

10. The system of claim 1, wherein the photo sensor detects multiple groups of consecutive pixels at respective time instants, and the controller is operative to compute an average of detection pulse widths in clock cycles.

11. The system of claim 1, wherein the controller is further operative to compute a center point of the detection pulse width in clock cycles.

12. The system of claim 1, wherein the clock cycles have a frequency that is higher than the number of pixels in a horizontal scan cycle.

13. A method for calibrating laser beam scanning, comprising:
generating a control signal and a drive signal by a controller, wherein the control signal turns a laser beam on and off, and the drive signal controls scan movements of a micro-mirror that deflects the laser beam to create a scan trajectory on a projection;
receiving, by the controller, a detection pulse from a photo sensor placed at a margin of the projection, wherein the photo sensor is underneath a light-blocking top layer having a slot to expose the photo sensor, and a detection pulse width indicates a segment of the scan trajectory detected by the phone sensor; and
measuring the detection pulse width in clock cycles.

14. The method of claim 13, further comprising:
comparing a measured number of clock cycles (D2) with D1, wherein D1 is a number of clock cycles when corresponding pixels in segments of the scan trajectory form a vertical line.

15. The method of claim 13, further comprising:
turning on the laser beam to generate N consecutive pixels in each of the one or more segments of the scan trajectory.

16. The method of claim 15, wherein a width of the slot is equal to a width of the N consecutive pixels.

17. The method of claim 13, wherein the photo sensor is positioned in a dark field of the projection where the laser beam is turned on and off for calibration.

18. The method of claim 13, wherein a vertical center line of the slot is aligned with or parallel to a vertical center line of the projection.

19. The method of claim 13, further comprising:
detecting, by the photo sensor through the slot, multiple groups of consecutive pixels at respective time instants; and
computing, by the controller, an average of detection pulse widths in clock cycles.

20. The method of claim 13, wherein the clock cycles have a frequency that is higher than the number of pixels in a horizontal scan cycle.
